(19) United States
(12) Patent Application Publication
(10) Pub. No.: US 2024/0210722 A1
(43) Pub. Date: Jun. 27, 2024

(54) POLARIZATION MODULATION ELEMENT, SMART GLASS, ONE-WAY MIRROR, DISPLAY DEVICE, AND THREE-DIMENSIONAL-IMAGE DISPLAY DEVICE

(71) Applicant: Shanghai Tianma Micro-Electronics Co., Ltd., Shanghai (CN)

(72) Inventors: Tetsurou TASHIRO, Kawasaki (JP); Tetsushi SATO, Kawasaki (JP)

(73) Assignee: Shanghai Tianma Micro-Electronics Co., Ltd., Shanghai (CN)

(21) Appl. No.: 18/526,871

(22) Filed: Dec. 1, 2023

(30) Foreign Application Priority Data
Dec. 26, 2022 (JP) 2022-208153

(51) Int. Cl. G02B 30/25; G02F 1/1337; G02F 1/1347; G02F 1/137

(52) U.S. Cl. CPC G02B 30/25; G02F 1/1337; G02F 1/1347; G02F 1/137; G02F 2203/01

(57) ABSTRACT

A polarization modulation element includes a light incident-side substrate on which linearly polarized light is incident, a light emitting-side substrate opposing the light incident-side substrate, a nematic liquid crystal layer that is twist-aligned and is sandwiched between the light incident-side substrate and the light emitting-side substrate, and a polymer that is dispersed in the nematic liquid crystal layer and that is aligned according to a twist-alignment of nematic liquid crystal layer. An alignment axis direction of the light incident-side substrate and a polarization direction of the linearly polarized light are orthogonal to each other.

### CROSS-REFERENCE TO RELATED APPLICATIONS

This application claims the benefit of Japanese Patent Application No. 2022-208153, filed on Dec. 26, 2022, the entire disclosure of which is incorporated by reference herein.

### FIELD OF THE INVENTION

The present disclosure relates generally to a polarization modulation element, a smart glass, a one-way mirror, a display device and a three-dimensional-image display device.

### BACKGROUND OF THE INVENTION

Display devices, optical switches, optical path deflection elements, and the like that include a polarization modulation element that uses a twisted nematic liquid crystal are known in the related art. For example, Unexamined Japanese Patent Application Publication No. 2005-129983 describes a three-dimensional display device including a display device that alternately displays two two-dimensional images, a polarizing plate that emits emission light from the display device as polarized light, a polarization switching device (polarization modulation element) that switches the polarization direction of the emission light emitted from the polarizing plate, and a polarized bifocal lens. Additionally, Unexamined Japanese Patent Application Publication No. 2009-14843 describes an optical path deflection element that includes first to fourth substrates. An optical path deflection liquid crystal layer is provided between the first substrate and the second substrate, and between the third substrate and the fourth substrate. Additionally, a polarizing plane rotation liquid crystal layer that rotates a polarizing plane of linearly polarized light is provided between the second substrate and the third substrate. The polarizing plane rotation liquid crystal layer of Unexamined Japanese Patent Application Publication No. 2009-14843 is a twisted nematic liquid crystal layer. In Unexamined Japanese Patent Application Publication No. 2009-14843, the liquid crystal layer contains a polymer material in order to stabilize the alignment of the liquid crystal layer. The polymer material has a chain-like or three-dimensional mesh-like shape, and is uniformly dispersed in the liquid crystal layer.

Meanwhile, liquid crystal display elements that contain polymers in the liquid crystal composition in order to shorten response time are known in the related art. For example, Japanese Patent No. 6090482 describes a liquid crystal display element (excluding light-scattering elements) that contains a polymer or a copolymer of a polymerizable compound in a liquid crystal composition sandwiched between transparent substrates. In Japanese Patent No. 6090482, the polymer or copolymer forms a polymer network, and an optical axis direction or an easy alignment axis direction of the polymer network and an easy alignment axis direction of the small molecule liquid crystal are the same direction.

The elements of Unexamined Japanese Patent Application Publication No. 2009-14843 and Japanese Patent No. 6090482 are not elements that scatter incident light and, in the elements of Unexamined Japanese Patent Application Publication No. 2009-14843 and Japanese Patent No. 6090482, no consideration is made for the scattering of incident light. Moreover, Unexamined Japanese Patent Application Publication No. 2009-14843 and Japanese Patent No. 6090482 do not describe the scattering of incident light in any way.

### SUMMARY OF THE INVENTION

A polarization modulation element according to a first aspect includes:
a light incident-side substrate on which linearly polarized light is incident;
a light emitting-side substrate opposing the light incident-side substrate;
a nematic liquid crystal layer that is twist-aligned and is sandwiched between the light incident-side substrate and the light emitting-side substrate; and
a polymer that is dispersed in the nematic liquid crystal layer and that is aligned according to a twist-alignment of the nematic liquid crystal layer, wherein
an alignment axis direction of the light incident-side substrate and a polarization direction of the linearly polarized light are orthogonal to each other.

A polarization modulation element according to a second aspect includes:
a plurality of twisted nematic liquid crystal cells, each including a light incident-side substrate, a light emitting-side substrate opposing the light incident-side substrate, a nematic liquid crystal layer that is twist-aligned and is sandwiched between the light incident-side substrate and the light emitting-side substrate, and a polymer that is dispersed in the nematic liquid crystal layer and that is aligned according to a twist-alignment of the nematic liquid crystal layer, wherein
a twist direction of the nematic liquid crystal layer of each of the plurality of twisted nematic liquid crystal cells is identical,
the plurality of nematic liquid crystal cells are sequentially stacked with the light incident-side substrate of one of the twisted nematic liquid crystal cells opposing the light emitting-side substrate of another of the twisted nematic liquid crystal cells,
in the twisted nematic liquid crystal cells that are adjacent, of the plurality of twisted nematic liquid crystal cells, an alignment axis direction of the light emitting-side substrate of one of the nematic liquid crystal cells and an alignment axis direction of the light incident-side substrate of another of the nematic liquid crystal cells match, and
an alignment axis direction of the light incident-side substrate of a first twisted nematic liquid crystal cell, of the plurality of twisted nematic liquid crystal cells, on which linearly polarized light is incident and a polarization direction of the linearly polarized light are orthogonal to each other.

A polarization modulation element according to a third aspect includes:
three or more twisted nematic liquid crystal cells, each including a light incident-side substrate, a light emitting-side substrate opposing the light incident-side substrate, a nematic liquid crystal layer that is twist-aligned and is sandwiched between the light incident-side substrate and the light emitting-side substrate, and a polymer that is dispersed in the nematic liquid crystal layer and that is aligned according to a twist-alignment of the nematic liquid crystal layer, wherein
a twist direction of the nematic liquid crystal layer of each of the twisted nematic liquid crystal cells is identical,
the twisted nematic liquid crystal cells are sequentially stacked with the light incident-side substrate of one of the twisted nematic liquid crystal cells opposing the light emitting-side substrate of another of the twisted nematic liquid crystal cells,
in at least one group of the twisted nematic liquid crystal cells that are adjacent, an alignment axis direction of the light emitting-side substrate of one of the twisted nematic liquid crystal cells and an alignment axis direction of the light incident-side substrate of another of the twisted nematic liquid crystal cells are orthogonal to each other,
in the twisted nematic liquid crystal cells that are adjacent, except for the at least one group of the twisted nematic liquid crystal cells that are adjacent, the alignment axis direction of the light emitting-side substrate of one of the twisted nematic liquid crystal cells and the alignment axis direction of the light incident-side substrate of another of the twisted nematic liquid crystal cells match, and
an alignment axis direction of the light incident-side substrate of a first twisted nematic liquid crystal cell, of the twisted nematic liquid crystal cells, on which linearly polarized light is incident and a polarization direction of the linearly polarized light are orthogonal to each other.

A smart glass according to a fourth aspect includes:
the polarization modulation element;
a light-transmitting substrate that is disposed on a side of the polarization modulation element on which the linearly polarized light is incident, and on which external light is incident;
a first polarizing plate that is disposed between the light-transmitting substrate and the polarization modulation element, and that emits, to the polarization modulation element, the external light that transmits through the light-transmitting substrate as the linearly polarized light incident on the polarization modulation element; and
a second polarizing plate on which emission light emitted from the polarization modulation element is incident, and that has a transmission axis that is orthogonal to a transmission axis of the first polarizing plate.

A one-way mirror according to a fifth aspect includes:
the polarization modulation element;
a half mirror that is disposed on a side of the polarization modulation element on which the linearly polarized light is incident, and on which external light is incident;
a first polarizing plate that is disposed between the half mirror and the polarization modulation element, and that emits, to the polarization modulation element, the external light that transmits through the half mirror as the linearly polarized light incident on the polarization modulation element; and
a second polarizing plate on which emission light emitted from the polarization modulation element is incident, and that has a transmission axis that is orthogonal to a transmission axis of the first polarizing plate.

A display device according to a sixth aspect includes:
the polarization modulation element;
a display panel that is disposed on a side of the polarization modulation element on which the linearly polarized light is incident, and that emits display light toward the polarization modulation element;
a first polarizing plate that is disposed between the polarization modulation element and the display panel, and that emits, to the polarization modulation element, the display light of the display panel as the linearly polarized light incident on the polarization modulation element;
a second polarizing plate on which emission light emitted from the polarization modulation element is incident, and that has a transmission axis that is orthogonal to a transmission axis of the first polarizing plate; and
a half mirror on which the emission light of the polarization modulation element that transmits through the second polarizing plate is incident.

A three-dimensional-image display device according to a seventh aspect includes:
the polarization modulation element;
a display unit that sequentially displays a first image and a second image, and emits display light of the first image and display light of the second image as the linearly polarized light, that enters the polarization modulation element, for which a polarization direction is a predetermined first direction; and
a polarized bifocal lens into which emission light emitted from the polarization modulation element enters, and in which a focal distance for the emission light emitted from the polarization modulation element differs based on the polarization direction of the emission light, wherein
the first image and the second image are two-dimensional images obtained by projecting, from a side of an observer, a display subject on each of a first display surface and a second display surface positioned at different positions in a depth direction from a perspective of the observer,
the polarization modulation element maintains the polarization direction of the linearly polarized light in the predetermined first direction and emits when the linearly polarized light is the display light of the first image, and changes the polarization direction of the linearly polarized light to a second direction orthogonal to the predetermined first direction and emits when the linearly polarized light is the display light of the second image, thereby switching the polarization direction of the emission light between the predetermined first direction and the second direction and emitting, and
the polarized bifocal lens forms each of the first image and the second image as a virtual image on each of the first display surface and the second display surface.

It is to be understood that both the foregoing general description and the following detailed description are exemplary and explanatory and are not restrictive of this disclosure.

### BRIEF DESCRIPTION OF DRAWINGS

A more complete understanding of this application can be obtained when the following detailed description is considered in conjunction with the following drawings, in which:

FIG. 1 is a schematic view illustrating a cross-section of a polarization modulation element according to Embodiment 1;

FIG. 2 is a schematic drawing illustrating an alignment axis direction according to Embodiment 1;

FIG. 3 is a drawing illustrating an alignment axis direction and an alignment of a nematic liquid crystal layer according to Embodiment 1;

FIG. 4 is a drawing illustrating a haze value of the polarization modulation element according to Embodiment 1, in an initial alignment state;

FIG. 5 is a drawing illustrating the haze value of the polarization modulation element according to Embodiment 1, in an ON state;

FIG. 6 is a schematic drawing illustrating a cross-section of a polarization modulation element according to Embodiment 2;

FIG. 7 is a schematic drawing illustrating a cross-section of a TN cell according to Embodiment 2;

FIG. 8 is a drawing illustrating an alignment axis direction and an alignment of a nematic liquid crystal layer of a first TN cell according to Embodiment 2;

FIG. 9 is a drawing illustrating the alignment axis direction and the alignment of the nematic liquid crystal layer of a second TN cell according to Embodiment 2;

FIG. 10 is a drawing illustrating the alignment axis direction and the alignment of the nematic liquid crystal layer of a third TN cell according to Embodiment 2;

FIG. 11 is a drawing illustrating the alignment axis direction and the alignment of the nematic liquid crystal layer of a fourth TN cell according to Embodiment 2;

FIG. 12 is a schematic drawing illustrating an alignment state of the nematic liquid crystal layer of the polarization modulation element according to Embodiment 2, in an initial state;

FIG. 13 is a drawing illustrating a haze value of the polarization modulation element according to Embodiment 2, in an initial alignment state;

FIG. 14 is a drawing illustrating the haze value of the polarization modulation element according to Embodiment 2, in an ON state;

FIG. 15 is a drawing illustrating an alignment axis direction and an alignment of a nematic liquid crystal layer of a third TN cell according to Embodiment 3;

FIG. 16 is a drawing illustrating the alignment axis direction and the alignment of the nematic liquid crystal layer of a fourth TN cell according to Embodiment 3;

FIG. 17 is a schematic drawing illustrating an alignment state of a nematic liquid crystal layer of a polarization modulation element according to Embodiment 3, in an initial state;

FIG. 18 is a drawing illustrating a haze value of the polarization modulation element according to Embodiment 3, in an initial alignment state;

FIG. 19 is a drawing illustrating the haze value of the polarization modulation element according to Embodiment 3, in an ON state;

FIG. 20 is a schematic drawing illustrating the alignment state of the nematic liquid crystal layer of the polarization modulation element according to Embodiment 3, in the ON state;

FIG. 21 is a schematic drawing illustrating a smart glass in which a polarization modulation element is in an initial alignment state, according to Embodiment 4;

FIG. 22 is a schematic drawing illustrating the smart glass in which the polarization modulation element in is an ON state, according to Embodiment 4;

FIG. 23 is a schematic drawing illustrating a one-way mirror in which a polarization modulation element is in an initial alignment state, according to Embodiment 5;

FIG. 24 is a schematic drawing illustrating a one-way mirror in which the polarization modulation element is in an ON state, according to Embodiment 5;

FIG. 25 is a schematic drawing illustrating a display device in which a polarization modulation element is in an initial alignment state, according to Embodiment 6;

FIG. 26 is a schematic drawing illustrating the display device in which the polarization modulation element is in an ON state, according to Embodiment 6;

FIG. 27 is a schematic drawing illustrating a three-dimensional-image display device according to Embodiment 7;

FIG. 28 is a plan view illustrating a liquid crystal display panel according to Embodiment 7;

FIG. 29 is a cross-sectional view illustrating a polarized bifocal lens according to Embodiment 7;

FIG. 30 is a block diagram illustrating a controller according to Embodiment 7; and

FIG. 31 is a drawing illustrating the hardware configuration of the controller according to Embodiment 7.

### DETAILED DESCRIPTION OF THE INVENTION

Hereinafter, a polarization modulation element, a smart glass, a one-way mirror, a display device, and a three-dimensional-image display device according to embodiments are described while referencing the drawings.

### Embodiment 1

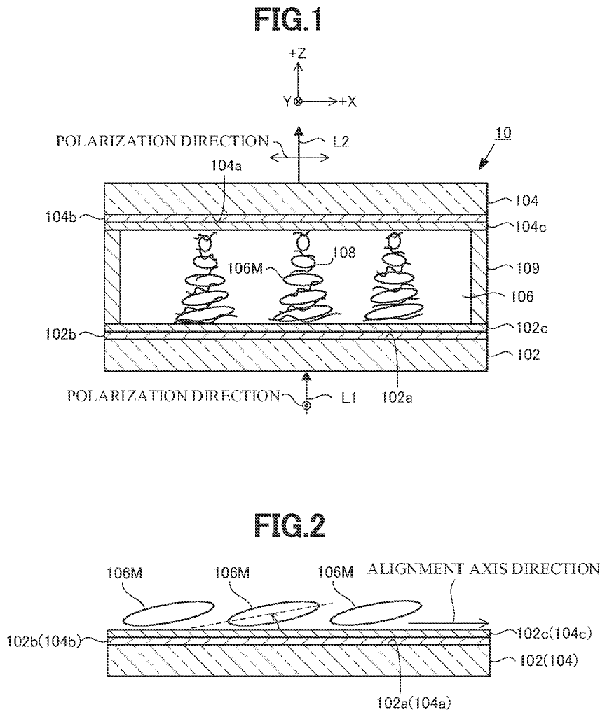

A polarization modulation element 10 according to the present embodiment is described while referencing FIGS. 1 to 5. As illustrated in FIG. 1, the polarization modulation element 10 includes a light incident-side substrate 102, a light emitting-side substrate 104, a nematic liquid crystal layer 106, and a polymer 108. In a state in which voltage is not applied to the nematic liquid crystal layer 106 (hereinafter referred to as an “initial alignment state”), the polarization modulation element 10 rotates a polarization direction of linearly polarized light (incident light) L1 incident on the polarization modulation element 10 90°, and emits this light as emission light L2. In a state in which a predetermined voltage is applied to the nematic liquid crystal layer 106 (hereinafter referred to as an “ON state”), the polarization modulation element 10 maintains the polarization direction of the linearly polarized light L1 incident on the polarization modulation element 10, and emits this light as the emission light L2. The polarization modulation element 10 is implemented as a polarization modulation element in which the polymer 108 is dispersed in the nematic liquid crystal layer 106 in order to shorten a response time of the polarization modulation element 10 (a so-called “polymer stabilized liquid crystal element”). The polarization modulation element 10 is not a light-scattering liquid crystal element that transmits or scatters incident light (a so-called “polymer dispersed liquid crystal element” or a “polymer network liquid crystal element”).

In the present specification, to facilitate comprehension, a description is given in which, in FIG. 1, the right direction (the right direction on paper) of the polarization modulation element 10 is referred to as the “+X direction”, the up direction (the up direction on paper) is referred to as the “+Z direction”, and the direction perpendicular to the +X direction and the +Z direction (the depth direction on paper) is referred to as the “+Y direction.” The polarization direction of the linearly polarized light L1 incident on the polarization modulation element 10 is set as the “Y direction.”

The light incident-side substrate 102 of the polarization modulation element 10 is a substrate on which the linearly polarized light L1 is incident. The light incident-side substrate 102 opposes the light emitting-side substrate 104. The light incident-side substrate 102 and the light emitting-side substrate 104 sandwich the nematic liquid crystal layer 106. In one example, the light incident-side substrate 102 is implemented as a glass substrate. The light incident-side substrate 102 includes a light-transmitting electrode 102b and an alignment film 102c on a main surface 102a that opposes the light emitting-side substrate 104.

The light-transmitting electrode 102b of the light incident-side substrate 102 is formed on the entire surface of the main surface 102a. The light-transmitting electrode 102b is formed from indium tin oxide (ITO). The alignment film 102c of the light incident-side substrate 102 aligns the nematic liquid crystal layer 106 in a predetermined direction. In one example, the alignment film 102c of the light incident-side substrate 102 is implemented as an alignment-treated polyimide alignment film. The alignment of the nematic liquid crystal layer 106 is described later.

As illustrated in FIG. 1, the light emitting-side substrate 104 of the polarization modulation element 10 is a substrate from which the emission light L2 is emitted. The light incident-side substrate 102 and the light emitting-side substrate 104 are affixed to each other by a seal material 109. In one example, the light emitting-side substrate 104 is implemented as a glass substrate. The light emitting-side substrate 104 includes a light-transmitting electrode 104b and an alignment film 104c on a main surface 104a that opposes the light incident-side substrate 102.

The light-transmitting electrode 104b of the light emitting-side substrate 104 is formed on the entire surface of the main surface 104a. The light-transmitting electrode 104b is formed from indium tin oxide (ITO). The alignment film 104c of the light emitting-side substrate 104 aligns the nematic liquid crystal layer 106 in a predetermined direction. In one example, the alignment film 104c of the light emitting-side substrate 104 is implemented as an alignment-treated polyimide alignment film.

The nematic liquid crystal layer 106 of the polarization modulation element 10 is formed from a nematic liquid crystal composition that has positive dielectric anisotropy Δε, and is sandwiched by the light incident-side substrate 102 and the light emitting-side substrate 104. In one example, a refractive index anisotropy Δn of the nematic liquid crystal composition is 0.1403 at a wavelength of 589.2 nm (extraordinary light refractive index; 1.6347, ordinary light refractive index: 1.4944). In one example, a thickness of the nematic liquid crystal layer 106 is 6.0 μm.

As with the liquid crystal layer of a typical twisted nematic (TN) liquid crystal element, in the initial alignment state, the nematic liquid crystal layer 106 is twist-aligned by the alignment film 102c of the light incident-side substrate 102 and the alignment film 104c of the light emitting-side substrate 104. In the present specification, as illustrated in FIG. 2, an initial alignment direction of liquid crystal molecules 106M at the interface between the nematic liquid crystal composition and the alignment film 102c or the alignment film 104c is defined as an alignment axis direction of the light incident-side substrate 102 or the light emitting-side substrate 104.

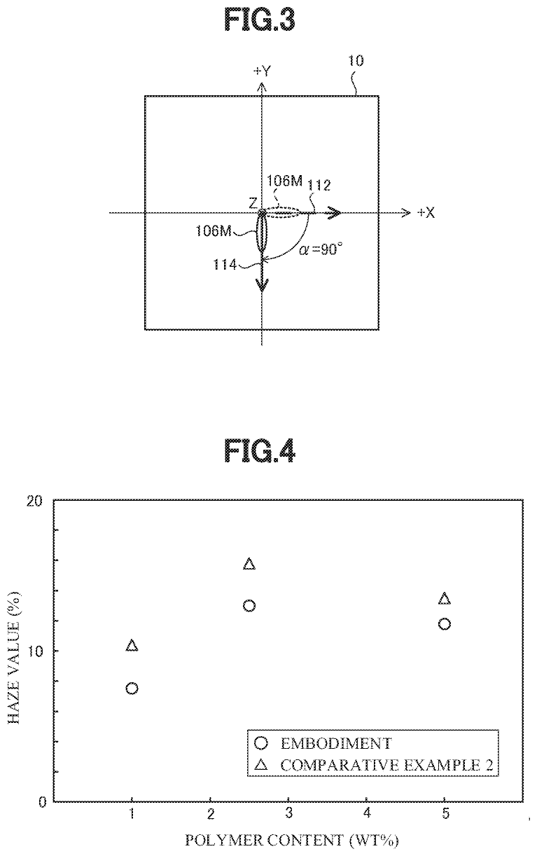

As illustrated in FIG. 3, in the present embodiment, an alignment axis direction 112 of the light incident-side substrate 102 is the +X direction, and is orthogonal to the polarization direction of the linearly polarized light L1. An alignment axis direction 114 of the light emitting-side substrate 104 is the −Y direction. When viewed from above from the +Z side, the nematic liquid crystal layer 106 in the initial alignment state is twist-aligned clockwise at a twist angle α90°.

The polymer 108 of the polarization modulation element 10 is dispersed in the nematic liquid crystal layer 106. The polymer 108 is aligned according to the twist-alignment of the nematic liquid crystal layer 106 in the initial alignment state. Note that, in the present specification, the term “polymer 108” refers to a polymer or a copolymer of a polymerizable compound.

The polymer 108 is formed from an ultraviolet (UV) curing or heat curing polymerizable compound (also called “reactive mesogen”). In one example, the polymer 108 is formed by sandwiching a composition, obtained by adding the polymerizable compound to the nematic liquid crystal composition, between the light incident-side substrate 102 and the light emitting-side substrate 104 and, then, curing the polymerizable compound. It is preferable that a content of the polymer 108, with respect to the nematic liquid crystal composition forming the nematic liquid crystal layer 106, is from 1 wt % to 10 wt %. In one example, the ordinary light refractive index and the extraordinary light refractive index of the polymer 108 are respectively approximately the same as the ordinary light refractive index and the extraordinary light refractive index of the nematic liquid crystal composition. Examples of the polymerizable compound include the polymerizable compounds described in Japanese Patent No. 6090482, Unexamined Japanese Patent Application Publication No. 2009-132718, and the like.

Next, the operations and effects of the polarization modulation element 10 are described. In the present embodiment, the polymer 108 is dispersed in the nematic liquid crystal layer 106. Furthermore, the polymer 108 is aligned according to the twist-alignment of the nematic liquid crystal layer 106 in the initial alignment state. The linearly polarized light L1 for which the polarization direction is the Y direction is incident on the light incident-side substrate 102 for which the alignment axis direction 112 is the +X direction. The polarization direction of the linearly polarized light L1 and the alignment axis direction 112 of the light incident-side substrate 102 are orthogonal to each other. The nematic liquid crystal layer 106 in the initial alignment state is twist-aligned 90° and, as such, when the linearly polarized light L1 enters, the polarization modulation element 10 in the initial alignment state rotates the polarization direction of the linearly polarized light L1 90° and emits this light as the emission light L2 for which the polarization direction is the X direction. Meanwhile, in the polarization modulation element 10 in the ON state (for example, a state in which 50V is applied), the liquid crystal molecules 106M of the nematic liquid crystal layer 106 are aligned perpendicular with respect to the light incident-side substrate 102 or the light emitting-side substrate 104. As such, when the linearly polarized light L1 enters, the polarization modulation element 10 maintains the polarization direction of the linearly polarized light L1 and emits this light as the emission light L2.

Firstly, the response time of the polarization modulation element 10 is described. Table 1 below illustrates the response times Ton, Toff of the polarization modulation element 10 and a polarization modulation element of Comparative Example 1. With the exception of the polymer 108 not being included in the nematic liquid crystal layer 106, the polarization modulation element of Comparative Example 1 is a polarization modulation element identical to the polarization modulation element 10. The response time is calculated on the basis of a change in a luminance of the emission light L2 that transmits through an emission polarizing plate. The direction of a transmission axis of the emission polarizing plate is the Y direction. Specifically, the linearly polarized light L1 enters the polarization modulation element 10 or the polarization modulation element of Comparative Example 1 through an incident polarizing plate. Voltage (±20V, 50 Hz square wave) is applied to the polarization modulation element 10 or the polarization modulation element of Comparative Example 1, and the change of the luminance of the emission light L2 is measured through the emission polarizing plate. The response time Ton is an amount of time, at a time of voltage ON, required for the luminance of the emission light L2 that transmits through the emission polarizing plate to reach 90% of a maximum luminance from a minimum luminance. The response time Toff is an amount of time, at a time of voltage OFF, required for the luminance of the emission light L2 that transmits through the emission polarizing plate to reach 10% of the maximum luminance from the maximum luminance.

TABLE 1
Response time of polarization modulation element

| | Polymer content (wt %) | Ton (ms) | Toff (ms) |
|---|---|---|---|
| Embodiment | 1.0 | 0.16 | 10.80 |
| | 2.5 | 0.22 | 3.40 |
| | 5.0 | 0.16 | 1.30 |
| Comparative | 0.0 | 0.51 | 11.00 |
| Example 1 | | | |

As illustrated in Table 1, the response times Ton, Toff of the polarization modulation element 10 are shorter than the response times Ton, Toff of the polarization modulation element of Comparative Example 1. Accordingly, the polarization modulation element 10 includes the polymer 108 and, as such, can shorten the response times Ton, Toff.

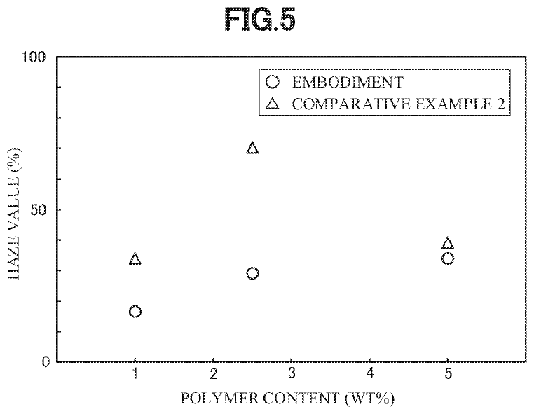

Next, scattering of the linearly polarized light L1 incident on the polarization modulation element 10 is described. FIG. 4 illustrates a haze value of the polarization modulation element 10 and a haze value of a polarization modulation element of Comparative Example 2, in the initial alignment state. FIG. 5 illustrates the haze value of the polarization modulation element 10 and the haze value of the polarization modulation element of Comparative Example 2, in the ON state. With the exception of the polarization direction (for example, the X direction) of the linearly polarized light incident on the light incident-side substrate being parallel to the alignment axis direction (for example, the +X direction) of the light incident-side substrate, the polarization modulation element of Comparative Example 2 is a polarization modulation element that is the same as the polarization modulation element 10. The haze value is measured by causing linearly polarized light to enter the polarization modulation element 10 or the polarization modulation element of Comparative Example 2 through the incident polarizing plate.

As illustrated in FIGS. 4 and 5, the haze value of the polarization modulation element 10 is smaller than the haze value of the polarization modulation element of Comparative Example 2. Accordingly, the polarization modulation element 10 can suppress scattering of the linearly polarized light L1 incident on the polarization modulation element 10, and can convert the polarization direction of the linearly polarized light L1. In the polarization modulation element 10, the alignment axis direction 112 of the light incident-side substrate 102 and the polarization direction of the linearly polarized light L1 are orthogonal to each other and, as such, the linearly polarized light L1 advances to the nematic liquid crystal layer 106 as ordinary light. The polymer 108 is aligned according to the twist-alignment of the nematic liquid crystal layer 106, and the ordinary light refractive indexes of the nematic liquid crystal layer 106 and the polymer 108 are respectively less than the extraordinary light refractive index. Accordingly, it is estimated that a refractive index difference, in the nematic liquid crystal layer 106 relative to the linearly polarized light L1, occurring due to the nematic liquid crystal layer 106 containing the polymer 108 is small, and scattering of the linearly polarized light L1 is suppressed.

As described above, the polarization modulation element 10 can shorten the response times Ton, Toff. Furthermore, with the polarization modulation element 10, the alignment axis direction 112 of the light incident-side substrate 102 and the polarization direction of linearly polarized light L1 incident on the light incident-side substrate 102 are orthogonal to each other and, as such, the polarization modulation element 10 can suppress scattering of the linearly polarized light L1 and can convert the polarization direction of the linearly polarized light L1.

### Embodiment 2

In Embodiment 1, the polarization direction of the linearly polarized light L1 is converted by one nematic liquid crystal layer 106. A configuration is possible in which the polarization direction of the linearly polarized light L1 is converted by a plurality of nematic liquid crystal layers 106.

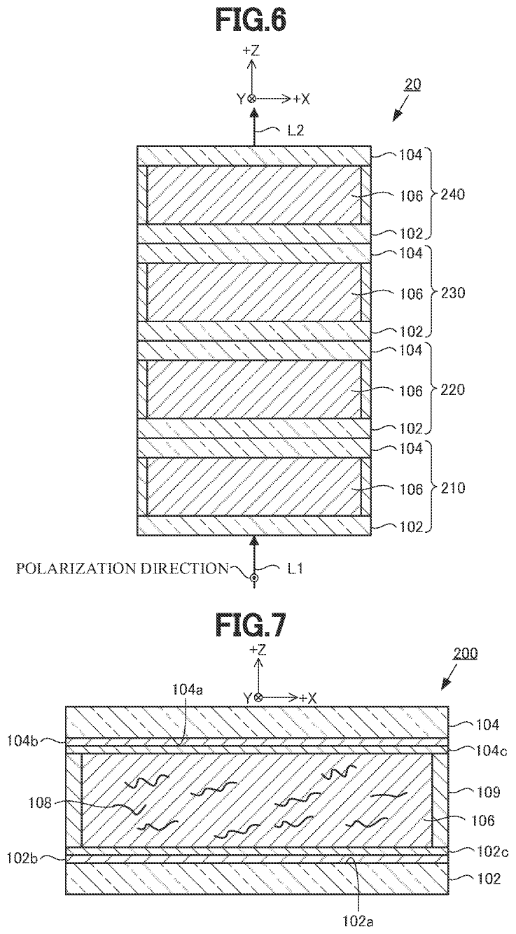

As illustrated in FIG. 6, a polarization modulation element 20 of the present embodiment includes four twisted nematic liquid crystal cells 210 to 240 for which the twist direction is identical. The polarization modulation element 20 is formed by sequentially stacking the twisted nematic liquid crystal cells 210 to 240 with non-illustrated adhesive layers provided therebetween. In an initial alignment state, the polarization modulation element 20 rotates a polarization direction of linearly polarized light L1 incident on the twisted nematic liquid crystal cell 210 90°, and emits this light as emission light L2. In an ON state, the polarization modulation element 20 maintains the polarization direction of the linearly polarized light L1 and emits this light as the emission light L2.

In the present specification, to facilitate comprehension, the twisted nematic liquid crystal cells may be referred to as TN cells, and may be referred to as an m^{th} (where m is an integer of 1 or greater) TN cell in order from the TN cell on which the linearly polarized light L1 is incident. Furthermore, the twisted nematic liquid crystal cells (TN cells) may be referred to collectively as “twisted nematic liquid crystal cells 200” or “TN cells 200.”

Firstly, the TN cells 200 are described. As illustrated in FIG. 7, each of the TN cells 200 includes a light incident-side substrate 102, a light emitting-side substrate 104, a nematic liquid crystal layer 106, and a polymer 108. With the exception of the alignment axis directions 212 to 244 and the twist-alignment of the nematic liquid crystal layer 106, described later, the configurations of the TN cells 210 to 240 are the same as those of the polarization modulation element 10 of Embodiment 1. Note that the light incident-side substrate 102 of each of the TN cells 200 is a substrate on which light (the linearly polarized light L1 or modulated linearly polarized light L1) is incident, and the light emitting-side substrate 104 of each of the TN cells 200 is a substrate from which light is emitted. Additionally, the alignment axis directions 212 to 244 of the TN cells 210 to 240 may be referred to collectively as “alignment axis directions 250.”

As illustrated in FIG. 6, the TN cells 200 are sequentially stacked with the light incident-side substrate 102 of one of the TN cells 200 and the light emitting-side substrate 104 of another of the TN cells 200 opposing each other.

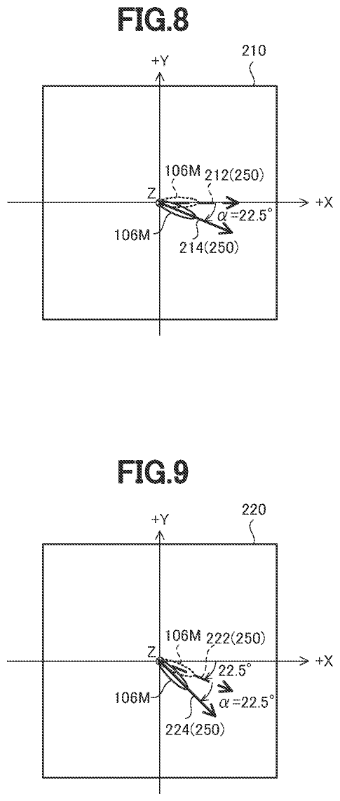

Next, the alignment axis directions 212 to 244 of the TN cells 210 to 240 and the twist-alignment of the nematic liquid crystal layer 106 are described. As illustrated in FIGS. 8 to 11, in the initial alignment state of the TN cells 210 to 240, the nematic liquid crystal layer 106 is aligned twisted clockwise when viewed from above from the +Z side. The twist angle α of the nematic liquid crystal layer 106 (that is, the twist angle of each of the TN cells 210 to 240) is 22.5°. The sum of the twist angles α of the nematic liquid crystal layer 106 of each of the TN cells 210 to 240 is of 90°.

In the TN cells 200 that are adjacent, the alignment axis direction 250 of the light emitting-side substrate 104 of one of the TN cells 200 and the alignment axis direction 250 of the light incident-side substrate 102 of another of the TN cells 200 match. Additionally, the alignment axis direction 212 of the light incident-side substrate 102 of the first TN cell 210 on which the linearly polarized light L1 is incident is orthogonal to the polarization direction (the Y direction) of the linearly polarized light L1.

Specifically, as illustrated in FIG. 8, in the first TN cell 210 on which the linearly polarized light L1 is incident, the alignment axis direction 212 of the light incident-side substrate 102 is the +X direction. An alignment axis direction 214 of the light emitting-side substrate 104 of the TN cell 210 is inclined 22.5° clockwise with respect to the +X direction.

As illustrated in FIG. 9, in the second TN cell 220, an alignment axis direction 222 of the light incident-side substrate 102 is inclined 22.5° clockwise with respect to the +X direction, and matches the alignment axis direction 214 of the light emitting-side substrate 104 of the TN cell 210. An alignment axis direction 224 of the light emitting-side substrate 104 of the TN cell 220 is inclined 45° clockwise with respect to the +X direction.

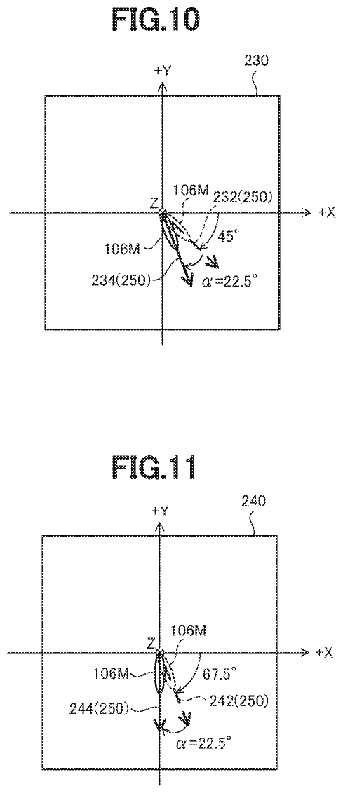

As illustrated in FIG. 10, in the third TN cell 230, an alignment axis direction 232 of the light incident-side substrate 102 is inclined 45° clockwise with respect to the +X direction, and matches the alignment axis direction 224 of the light emitting-side substrate 104 of the TN cell 220. An alignment axis direction 234 of the light emitting-side substrate 104 of the TN cell 230 is inclined 67.5° clockwise with respect to the +X direction.

As illustrated in FIG. 11, in the fourth TN cell 240, an alignment axis direction 242 of the light incident-side substrate 102 is inclined 67.5° clockwise with respect to the +X direction, and matches the alignment axis direction 234 of the light emitting-side substrate 104 of the TN cell 230. The alignment axis direction 244 of the light emitting-side substrate 104 of the TN cell 240 is inclined 90° clockwise (the −Y direction) with respect to the +X direction.

Next, the operations and effects of the polarization modulation element 20 are described. In the present embodiment, the linearly polarized light L1 for which the polarization direction is the Y direction is incident on the light incident-side substrate 102 of the first TN cell 210. The polarization direction of the linearly polarized light L1 and the alignment axis direction 112 of the light incident-side substrate 102 of the first TN cell 210 are orthogonal to each other.

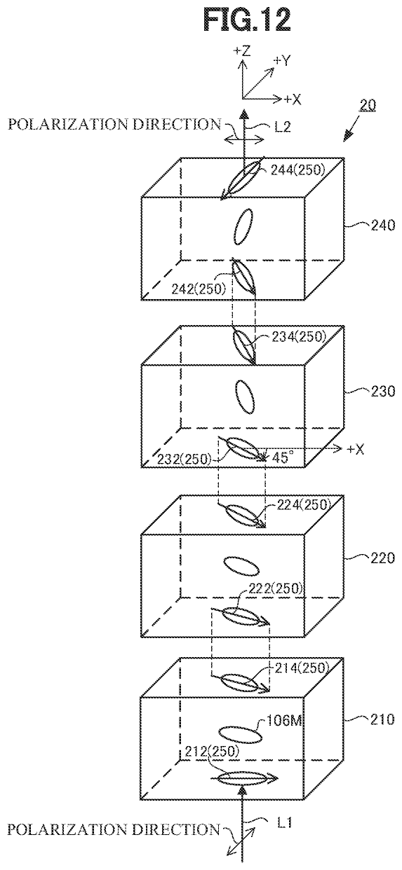

As illustrated in FIG. 12, in the initial alignment state, the nematic liquid crystal layer 106 of each of the TN cells 210 to 240 is twist-aligned. The nematic liquid crystal layers 106 of the TN cells 210 to 240 are twisted in the same direction, and the sum of the twist angles α is 90°. Accordingly, when the linearly polarized light L1 enters the polarization modulation element 20, the polarization modulation element 20 rotates the polarization direction of the linearly polarized light L1 90°, and emits emission light L2 for which the polarization direction is the X direction. Note that the light incident-side substrate 102, the light emitting-side substrate 104, and the like are omitted from FIG. 12. In some of the following drawings as well, the light incident-side substrate 102, the light emitting-side substrate 104, and the like may be omitted.

In the ON state, the liquid crystal molecules 106M of the TN cells 210 to 240 are aligned perpendicular to the light incident-side substrate 102 or the light emitting-side substrate 104. Accordingly, when the linearly polarized light L1 enters the polarization modulation element 20, the polarization modulation element 20 maintains the polarization direction of the linearly polarized light L1 and emits this light as the emission light L2.

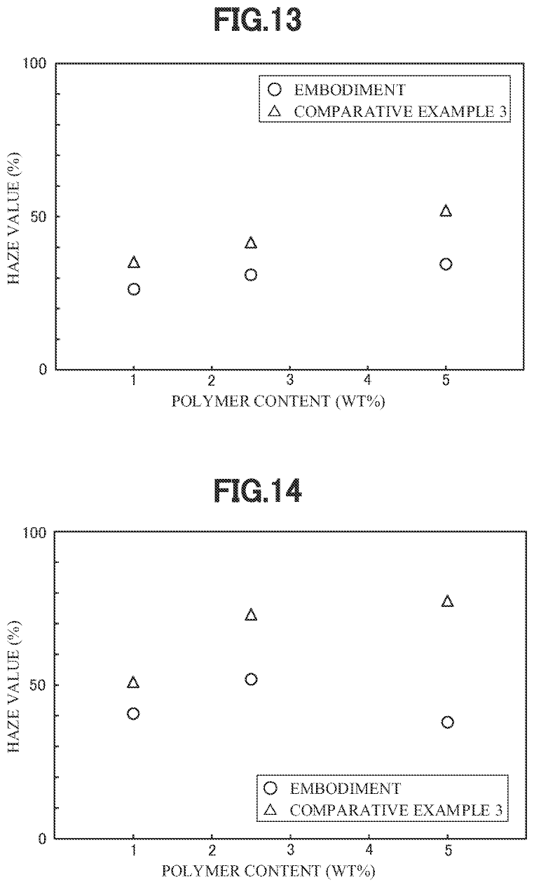

FIG. 13 illustrates a haze value of the polarization modulation element 20 and a haze value of a polarization modulation element of Comparative Example 3, in the initial alignment state. FIG. 14 illustrates the haze value of the polarization modulation element 20 and the haze value of the polarization modulation element of Comparative Example 3, in the ON state (application of 50V to each of the TN cells 200). With the exception of the polarization direction (for example, the X direction) of the linearly polarized light incident on the light incident-side substrate being parallel to the alignment axis direction (for example, the +X direction) of the light incident-side substrate on which the linearly polarized light is incident, the polarization modulation element of Comparative Example 3 is a polarization modulation element that is the same as the polarization modulation element 20. The method for measuring the haze value is the same as the method for measuring the haze value of Embodiment 1.

As illustrated in FIGS. 13 and 14, the haze value of the polarization modulation element 20 is smaller than the haze value of the polarization modulation element of Comparative Example 3. Accordingly, as with the polarization modulation element 10 of Embodiment 1, the polarization modulation element 20 can suppress scattering of the linearly polarized light L1 and can convert the polarization direction of the linearly polarized light L1.

As described above, with the polarization modulation element 20, the alignment axis direction 212 of the light incident-side substrate 102 of the first TN cell 210 on which the linearly polarized light L1 is incident and the polarization direction of the linearly polarized light L1 are orthogonal to each other and, as such, the polarization modulation element 20 can suppress scattering of the linearly polarized light L1 and can convert the polarization direction of the linearly polarized light L1. The TN cells 200 of the polarization modulation element 20 include the polymer 108 and, as such, the polarization modulation element 20 can shorten the response times Ton, Toff. Additionally, in the polarization modulation element 20, the twist angle α of each of the nematic liquid crystal layers 106 is small and, as such, the cell thickness (thickness of the nematic liquid crystal layer 106) of each of the TN cells 210 to 240 is reduced. As a result, the response times Ton, Toff of the polarization modulation element 20 can be shortened further.

### Embodiment 3

In Embodiment 2, the alignment axis direction 250 of the light emitting-side substrate 104 of one of the TN cells 200 and the alignment axis direction 250 of the light incident-side substrate 102 of another of the TN cells 200 match in the TN cells 200 that are adjacent. However, a configuration is possible in which, in at least one of the TN cells 200 that are adjacent, the alignment axis direction 250 of the light emitting-side substrate 104 of one of the TN cells 200 and the alignment axis direction 250 of the light incident-side substrate 102 of another of the TN cells 200 are orthogonal to each other.

As with the polarization modulation element 20 of Embodiment 2, a polarization modulation element 30 of the present embodiment includes four TN cells 210, 220, 230, 240 for which the twist direction is identical. In the present embodiment, an alignment axis direction 250 of the TN cells 230, 240 differs from the alignment axis direction 250 of the TN cells 230, 240 of Embodiment 2. The other configurations of the polarization modulation element 30 are the same as those of the polarization modulation element 20. Next, the alignment axis direction 250 of the TN cells 230, 240 of the present embodiment, and the operations and effects of the polarization modulation element 30 are described.

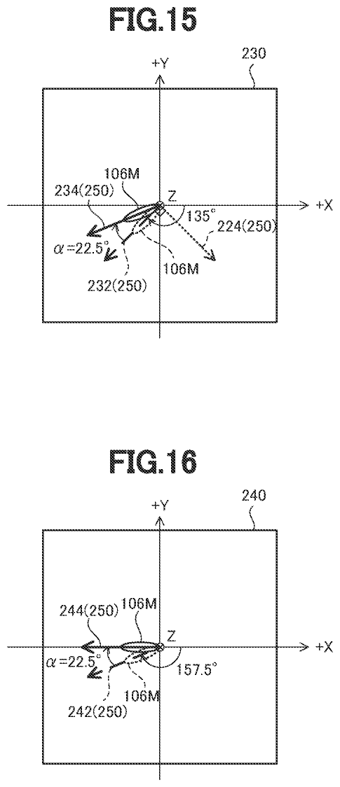

As illustrated in FIG. 15, in the third TN cell 230 of the present embodiment, an alignment axis direction 232 of the light incident-side substrate 102 is inclined 135° clockwise with respect to the +X direction, and is orthogonal to an alignment axis direction 224 of the light emitting-side substrate 104 of the TN cell 220. An alignment axis direction 234 of the light emitting-side substrate 104 of the TN cell 230 is inclined 157.5° clockwise with respect to the +X direction.

As illustrated in FIG. 16, in the fourth TN cell 240 of the present embodiment, an alignment axis direction 242 of the light incident-side substrate 102 is inclined 157.5° clockwise with respect to the +X direction, and matches the alignment axis direction 234 of the light emitting-side substrate 104 of the TN cell 230. An alignment axis direction 244 of the light emitting-side substrate 104 of the TN cell 240 is rotated 180° clockwise (the −X direction) with respect to the +X direction.

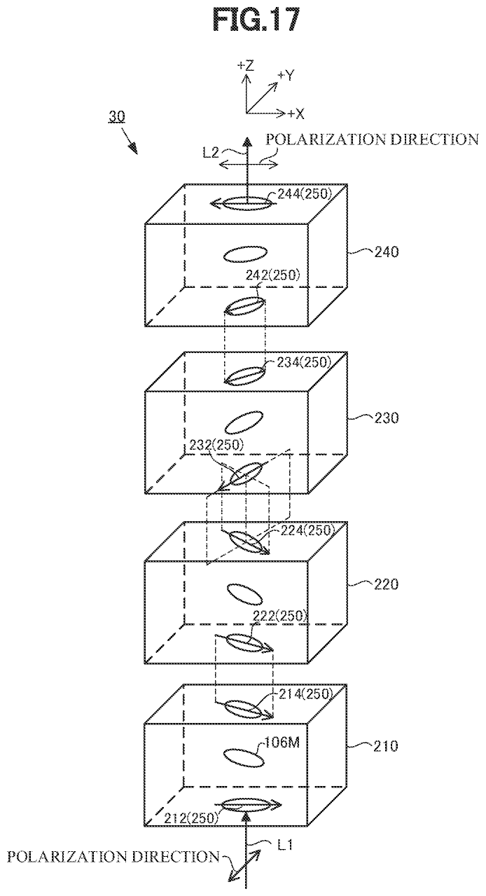

As illustrated in FIG. 17, in the initial alignment state of the polarization modulation element 30, the nematic liquid crystal layer 106 of each of the TN cells 210 to 240 is twist-aligned in the same direction, and the sum of the twist angles α is 90°. As with the polarization modulation element 20 of Embodiment 2, the polarization direction (the Y direction) of the linearly polarized light L1 and the alignment axis direction 212 (the +X direction) of the light incident-side substrate 102 of the first TN cell 210 are orthogonal to each other. Accordingly, as with the polarization modulation element 20 of Embodiment 2, when the linearly polarized light L1 enters the polarization modulation element 30, the polarization modulation element 30 rotates the polarization direction of the linearly polarized light L1 90°, and emits emission light L2 for which the polarization direction is the X direction.

In the ON state of the polarization modulation element 30, liquid crystal molecules 106M of the TN cells 210 to 240 are aligned perpendicular to the light incident-side substrate 102 or the light emitting-side substrate 104. Accordingly, when the linearly polarized light L1 enters the polarization modulation element 30, the polarization modulation element 30 maintains the polarization direction of the linearly polarized light L1 and emits this light as the emission light L2.

Table 2 below illustrates the response times Ton, Toff of the polarization modulation element 30 and a polarization modulation element of Comparative Example 4. With the exception of the TN cells 200 not including the polymer 108 in the nematic liquid crystal layer 106, the polarization modulation element of Comparative Example 4 is a polarization modulation element identical to the polarization modulation element 30. The method for measuring the response times Ton, Toff is the same as the method for measuring of Embodiment 1.

TABLE 2
Response time of polarization modulation element

| | Polymer content (wt %) | Ton (ms) | Toff (ms) |
|---|---|---|---|
| Embodiment | 1.0 | 0.10 | 7.83 |
| | 2.5 | 0.10 | 5.30 |
| | 5.0 | 0.09 | 4.66 |
| Comparative | 0.0 | 0.54 | 8.70 |
| Example 4 | | | |

As illustrated in Table 2, the response times Ton, Toff of the polarization modulation element 30 are shorter than the response times Ton, Toff of the polarization modulation element of Comparative Example 4. Accordingly, the TN cells 200 of the polarization modulation element 30 include the polymer 108 and, as such, the polarization modulation element 30 can shorten the response times Ton, Toff.

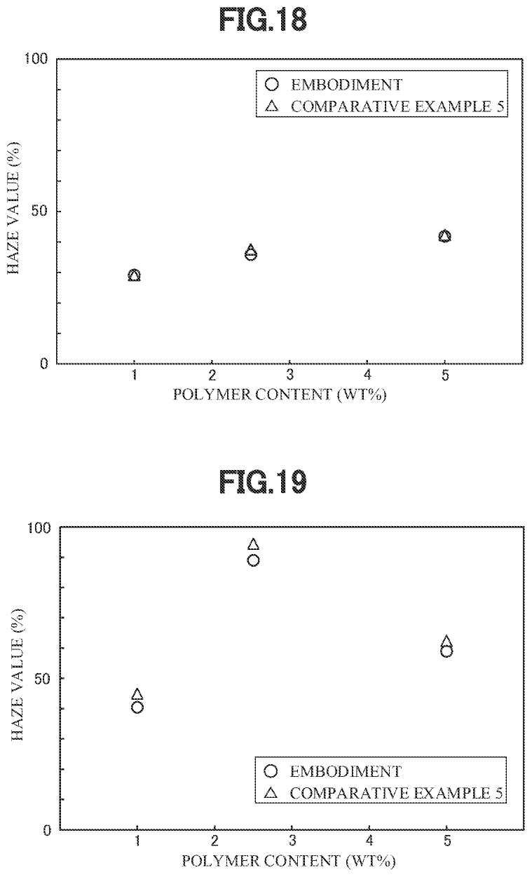

FIG. 18 illustrates a haze value of the polarization modulation element 30 and a haze value of a polarization modulation element of Comparative Example 5, in the initial alignment state. FIG. 19 illustrates the haze value of the polarization modulation element 30 and the haze value of the polarization modulation element of Comparative Example 5, in the ON state (application of 50V to each of the TN cells 200). With the exception of the polarization direction (for example, the X direction) of the linearly polarized light incident on the light incident-side substrate being parallel to the alignment axis direction (for example, the +X direction) of the light incident-side substrate on which the linearly polarized light is incident, the polarization modulation element of Comparative Example 5 is a polarization modulation element that is the same as the polarization modulation element 30. The method for measuring the haze value is the same as the method for measuring of Embodiment 1.

As illustrated in FIGS. 18 and 19, the haze value of the polarization modulation element 30 is smaller than the haze value of the polarization modulation element of Comparative Example 5. Accordingly, as with the polarization modulation element 20 of Embodiment 2, the polarization modulation element 30 can suppress scattering of the linearly polarized light L1 and can convert the polarization direction of the linearly polarized light L1.

Thus, the response times Ton, Toff of the polarization modulation element 30 can be shortened. Furthermore, with the polarization modulation element 30, the alignment axis direction 112 of the light incident-side substrate 102 of the first TN cell 210 on which the linearly polarized light L1 is incident and the polarization direction of the linearly polarized light L1 are orthogonal to each other and, as such, the polarization modulation element 30 can suppress scattering of the linearly polarized light L1 and can convert the polarization direction of the linearly polarized light L1.

In the ON state of the polarization modulation element 20 of Embodiment 2, the liquid crystal molecules 106M near the interfaces between the nematic liquid crystal layer 106 and the alignment films 102c, 104c do not sufficiently react to the electric field, and birefringence due to the liquid crystal molecules 106M may remain near the interfaces. Furthermore, the polarization modulation element 20 includes the plurality of TN cells 200 and, as such, in the polarization modulation element 20, the number of interfaces between the nematic liquid crystal layer 106 and the alignment films 102c, 104c is many. Accordingly, in the ON state of the polarization modulation element 20 of Embodiment 2, the emission light L2 may become elliptically polarized light due to the residual birefringence.

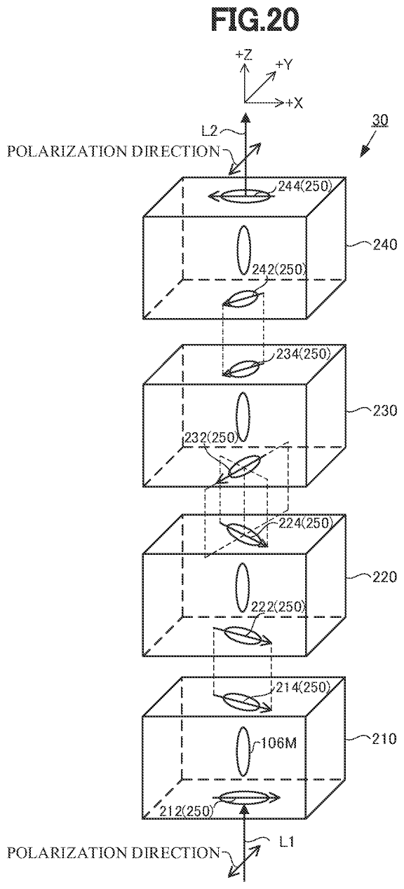

Meanwhile, in the ON state of the polarization modulation element 30, as illustrated in FIG. 20, in the second TN cell 220 and the third TN cell 230 that are adjacent, the alignment axis direction 224 of the light emitting-side substrate 104 of the TN cell 220 and the alignment axis direction 232 of the light incident-side substrate 102 of the TN cell 230 are orthogonal to each other and, as such, the residual birefringence near the interfaces is canceled out. Accordingly, the polarization modulation element 30 can sufficiently maintain the polarization direction of the linearly polarized light L1 and emit this light as the emission light L2.

### Embodiment 4

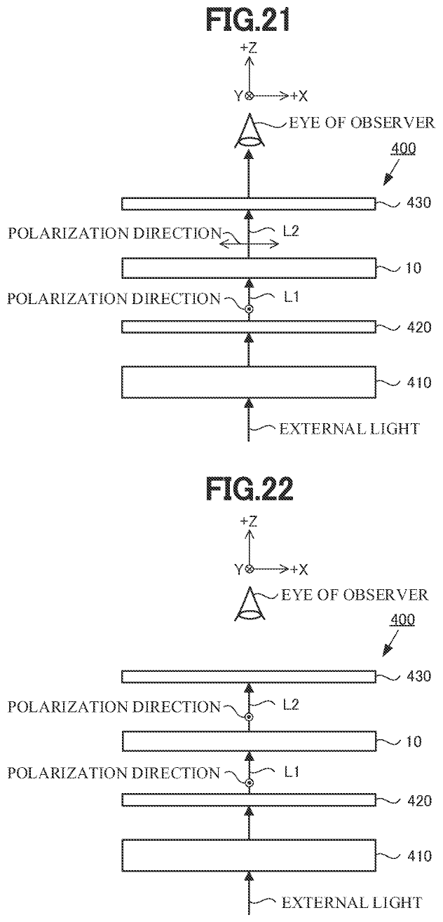

In the present embodiment, a smart glass 400 using the polarization modulation element 10 of Embodiment 1 is described. The smart glass 400 is used as window glass of a house, glass for a vehicle, or the like. As illustrated in FIG. 21, the smart glass 400 includes the polarization modulation element 10, a light-transmitting substrate 410, a first polarizing plate 420, and a second polarizing plate 430.

The light-transmitting substrate 410 of the smart glass 400 is disposed on a side of the polarization modulation element 10 on which the linearly polarized light L1 is incident (the −Z side of the polarization modulation element 10). The light-transmitting substrate 410 is formed from a light-transmitting resin, glass, or the like. In the present embodiment, external light enters the light-transmitting substrate 410 (the smart glass 400) from the −Z direction. Additionally, when, for example, the smart glass 400 is used as window glass of a house, the term “external light” refers to light that enters the smart glass 400 from outside.

The first polarizing plate 420 of the smart glass 400 is disposed between the polarization modulation element 10 and the light-transmitting substrate 410. The transmission axis of the first polarizing plate 420 is the Y direction, and the transmission axis of the first polarizing plate 420 is orthogonal to the alignment axis direction 112 (the +X direction) of the light incident-side substrate 102 of the polarization modulation element 10. The first polarizing plate 420 emits, to the polarization modulation element 10 and as linearly polarized light L1 for which the polarization direction is the Y direction, the external light that enters the smart glass 400 from the −Z direction.

The second polarizing plate 430 of the smart glass 400 is disposed on the side of the polarization modulation element 10 opposite the first polarizing plate 420 (on the +Z side of the polarization modulation element 10). The emission light L2 emitted from the polarization modulation element 10 enters the second polarizing plate 430. The direction of the transmission axis of the second polarizing plate 430 is the X direction, and is orthogonal to the transmission axis of the first polarizing plate 420.

Next, the operations of the smart glass 400 are described. The external light that enters the smart glass 400 from the −Z direction enters, via the light-transmitting substrate 410 and the first polarizing plate 420, the polarization modulation element 10 as linearly polarized light L1 for which the polarization direction is the Y direction. When the polarization modulation element 10 is in the initial alignment state, the polarization modulation element 10 rotates the polarization direction of the linearly polarized light L1 90°, and emits the linearly polarized light L1 as emission light L2 for which the polarization direction is the X direction. The direction of the transmission axis of the second polarizing plate 430 is the X direction and, as such, as illustrated in FIG. 21, the emission light L2 transmits through the second polarizing plate 430. Accordingly, the external light that enters the smart glass 400 from the −Z direction reaches the eye of an observer positioned on the +Z side of the smart glass 400 (for example, an observer who is indoors). That is, the observer positioned on the +Z side of the smart glass 400 can recognize landscapes, objects, and the like positioned on the −Z side of the smart glass 400. The polarization modulation element 10 can suppress scattering of the linearly polarized light L1 and, as such, the observer positioned on the +Z side of the smart glass 400 can see, through the smart glass 400, landscapes, objects, and the like with less blur.

Meanwhile, the light that enters the smart glass 400 from the +Z direction generally is weaker than the external light that enters the smart glass 400 from the −Z direction and, furthermore, is absorbed by the first polarizing plate 420 and the second polarizing plate 430. Accordingly, when the polarization modulation element 10 is in the initial alignment state, it is more difficult for an observer positioned on the −Z side of the smart glass 400 to recognize landscapes, objects, and the like positioned on the +Z side of the smart glass 400.

When voltage lower than a predetermined voltage is applied to the nematic liquid crystal layer 106 of the polarization modulation element 10, the liquid crystal molecules 106M of the nematic liquid crystal layer 106 rise in a direction perpendicular to the light incident-side substrate 102 or the light emitting-side substrate 104 and, as such, the emission light L2 emitted from the polarization modulation element 10 becomes elliptically polarized light. Accordingly, the light quantity of the emission light L2 that transmits through the second polarizing plate 430 decreases as the voltage applied to the nematic liquid crystal layer 106 increases. That is, landscapes, objects, and the like visible to the observer positioned on the +Z side of the smart glass 400 become darker. The polarization modulation element 10 can suppress scattering of the linearly polarized light L1 and, as such, the observer positioned on the +Z side of the smart glass 400 can see landscapes, objects, and the like with less blur. When this voltage is applied, it is more difficult for the observer positioned on the −Z side of the smart glass 400 to recognize landscapes, objects, and the like positioned on the +Z side of the smart glass 400 than when the polarization modulation element 10 is in the initial alignment state.

When the predetermined voltage is applied to the nematic liquid crystal layer 106 of the polarization modulation element 10 and the polarization modulation element 10 is in the ON state, the polarization modulation element 10 maintains the polarization direction of the linearly polarized light L1 and emits the linearly polarized light L1 as emission light L2 for which the polarization direction is the X direction. The direction of the transmission axis of the second polarizing plate 430 is the Y direction and, as such, as illustrated in FIG. 22, the emission light L2 cannot transmit through the second polarizing plate 430. Accordingly, the external light that enters the smart glass 400 from the −Z direction cannot reach the eye of the observer positioned on the +Z side of the smart glass 400, and the observer positioned on the +Z side of the smart glass 400 cannot see landscapes, objects, and the like positioned on the −Z side of the smart glass 400. Additionally, the observer positioned on the −Z side of the smart glass 400 also cannot see landscapes, objects, and the like positioned on the +Z side of the smart glass 400.

As described above, the polarization modulation element 10 can suppress scattering of the linearly polarized light L1 and, as such, the smart glass 400 can provide the observer with a field of vision with less blur.

### Embodiment 5

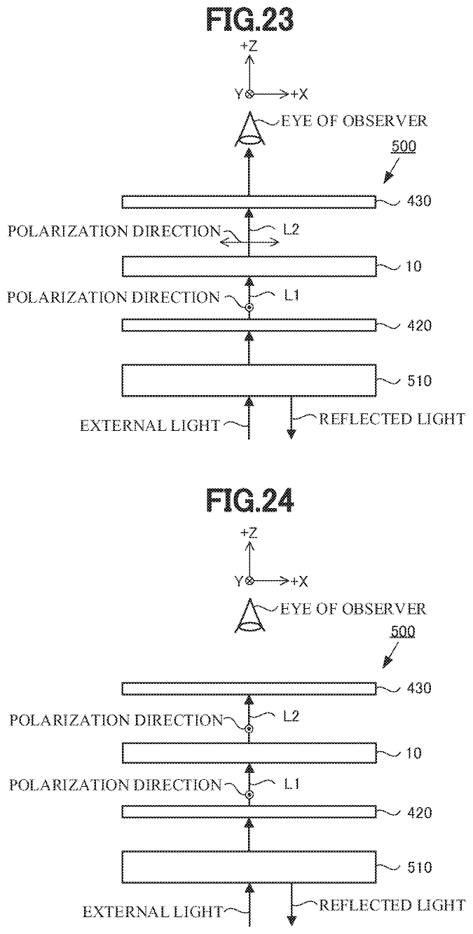

In the present embodiment, a one-way mirror 500 using the polarization modulation element 10 of Embodiment 1 is described. As illustrated in FIG. 23, the one-way mirror 500 includes a half mirror 510 instead of the light-transmitting substrate 410 of the smart glass 400. The first polarizing plate 420 and the second polarizing plate 430 of the present embodiment are the same as those of Embodiment 4.

The half mirror 510 is disposed on the side of the polarization modulation element 10 on which the linearly polarized light L1 is incident (the −Z side of the polarization modulation element 10). In the present embodiment, the external light enters the half mirror 510 (the one-way mirror 500) from the −Z direction. The half mirror 510 transmits a portion of the external light that enters from the −Z direction, and reflects another portion of the external light that enters from the −Z direction.

Next, the operations of the one-way mirror 500 are described. In the one-way mirror 500, the half mirror 510 reflects a portion of the external light that enters from the −Z direction. Accordingly, the one-way mirror 500 functions as a mirror with respect to an observer positioned on the −Z side of the one-way mirror 500, regardless of the state of the polarization modulation element 10.

A portion of the external light that enters the one-way mirror 500 from the −Z direction transmits through the half mirror 510. Accordingly, the portion of the external light that enters the one-way mirror 500 from the −Z direction enters, through the half mirror 510 and the first polarizing plate 420, the polarization modulation element 10 as linearly polarized light L1 for which the polarization direction is the Y direction. When the polarization modulation element 10 is in the initial alignment state, as with the external light that enters the smart glass 400 from the −Z direction in Embodiment 4, the external light that enters the one-way mirror 500 from the −Z direction reaches the eye of an observer positioned on the +Z side of the one-way mirror 500. The observer positioned on the +Z side of the one-way mirror 500 can recognize landscapes, objects, and the like positioned on the −Z side of the one-way mirror 500. The polarization modulation element 10 can suppress scattering of the linearly polarized light L1 and, as such, the observer positioned on the +Z side of the one-way mirror 500 can see, through the one-way mirror 500, landscapes, objects, and the like with less blur.

When voltage lower than the predetermined voltage is applied to the nematic liquid crystal layer 106 of the polarization modulation element 10, as with the smart glass 400 of Embodiment 4, landscapes, objects, and the like visible to the observer positioned on the +Z side of the one-way mirror 500 become darker. The polarization modulation element 10 can suppress scattering of the linearly polarized light L1 and, as such, the observer positioned on the +Z side of the smart glass 400 can see landscapes, objects, and the like with less blur.

When the polarization modulation element 10 is in the ON state, the polarization modulation element 10 maintains the polarization direction of the linearly polarized light L1, and emits the linearly polarized light L1 as emission light L2 for which the polarization direction is the X direction. The direction of the transmission axis of the second polarizing plate 430 is the Y direction and, as such, as illustrated in FIG. 24, the emission light L2 cannot transmit through the second polarizing plate 430. Accordingly, the observer positioned on the +Z side of the one-way mirror 500 cannot see landscapes, objects, and the like positioned on the −Z side of the one-way mirror 500.

As described above, the polarization modulation element 10 can suppress scattering of the linearly polarized light L1 and, as such, the one-way mirror 500 can provide the observer with a field of vision with less blur.

### Embodiment 6

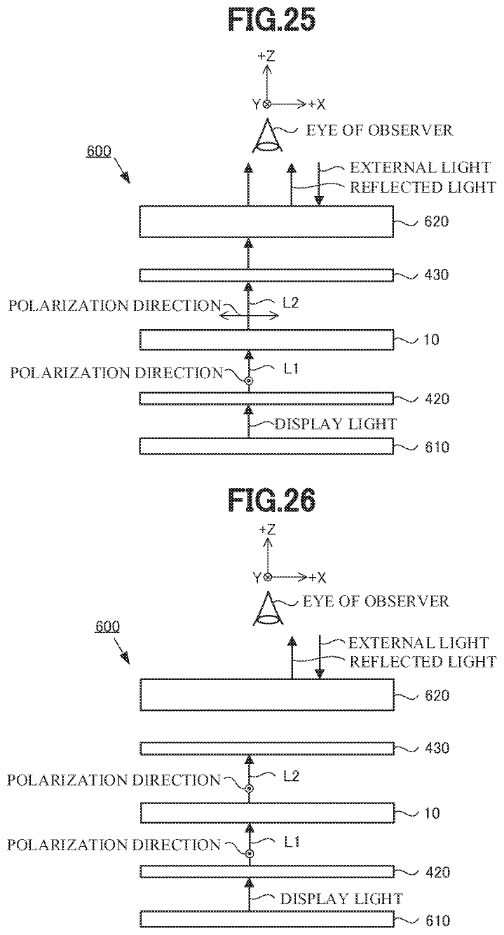

In the present embodiment, a display device 600 using the polarization modulation element 10 of Embodiment 1 is described. As illustrated in FIG. 25, the display device 600 includes the polarization modulation element 10, a display panel 610, a first polarizing plate 420, a second polarizing plate 430, and a half mirror 620.

The display panel 610 of the display device 600 is disposed on the side of the polarization modulation element 10 on which the linearly polarized light L1 is incident (the −Z side of the polarization modulation element 10). The display panel 610 displays characters, images, and the like, and emits, in the +Z direction toward the polarization modulation element 10, display light expressing the characters, images, and the like. The display panel 610 is implemented as a liquid crystal display panel, an organic electro-luminescence (EL) display panel, a micro light emitting diode (LED) display panel, or the like.

The first polarizing plate 420 of the display device 600 is disposed between the polarization modulation element 10 and the display panel 610. As with the first polarizing plate 420 of Embodiment 4, the direction of the transmission axis of the first polarizing plate 420 of the present embodiment is the Y direction, and the transmission axis of the first polarizing plate 420 of the present embodiment is orthogonal to the alignment axis direction 112 (the +X direction) of the light incident-side substrate 102 of the polarization modulation element 10. The first polarizing plate 420 of the present embodiment emits the display light emitted from the display panel 610 to the polarization modulation element 10 as linearly polarized light L1 for which the polarization direction is the Y direction.

As with the second polarizing plate 430 of Embodiment 4, the second polarizing plate 430 of the display device 600 is disposed on the side of the polarization modulation element 10 opposite the first polarizing plate 420 (on the +Z side of the polarization modulation element 10). The emission light L2 emitted from the polarization modulation element 10 enters the second polarizing plate 430 of the present embodiment. The direction of the transmission axis of the second polarizing plate 430 of the present embodiment is the X direction, and is orthogonal to the transmission axis of the first polarizing plate 420.

The half mirror 620 is disposed on the side of the second polarizing plate 430 opposite the polarization modulation element 10 (on the +Z side of the second polarizing plate 430). The emission light L2 of the polarization modulation element 10 that transmits through the second polarizing plate 430 enters the half mirror 620. The half mirror 620 transmits the emission light L2 that enters. Additionally, the half mirror 620 transmits a portion of the external light that enters from the +Z direction, and reflects another portion of the external light that enters from the +Z direction. Here, the external light is sunlight, illumination light, or the like.

Next, the operations of the display device 600 are described. When the display of the display panel 610 is bright, the display device 600 functions as a display device that displays, to an observer positioned on the +Z side of the display device 600, the display of the display panel 610 through the half mirror 620. When the display of the display panel 610 is dark, the display device 600 functions as a mirror that reflects the external light to the observer positioned on the +Z side of the display device 600.

When the polarization modulation element 10 is in the initial alignment state, the display light of the display panel 610 enters, through the first polarizing plate 420, the polarization modulation element 10 as linearly polarized light L1 for which the polarization direction is the Y direction. When the polarization modulation element 10 is in the initial alignment state, the polarization modulation element 10 rotates the polarization direction of the linearly polarized light L1 90°, and emits the linearly polarized light L1 as emission light L2 for which the polarization direction is the X direction. The transmission axis of the second polarizing plate 430 is the X direction and, as such, as illustrated in FIG. 25, the emission light L2 transmits through the second polarizing plate 430. The emission light L2 that transmits through the second polarizing plate 430 transmits through the half mirror 620 and reaches the eye of the observer positioned on the +Z side of the display device 600. Accordingly, the observer positioned on the +Z side of the display device 600 can recognize the display of the display panel 610. The polarization modulation element 10 can suppress scattering of the linearly polarized light L1 and, as such, the observer positioned on the +Z side of the display device 600 can see the display of the display panel 610 with less blur.

When voltage lower than a predetermined voltage is applied to the nematic liquid crystal layer 106 of the polarization modulation element 10, as with the smart glass 400 of Embodiment 4, the display of the display panel 610 visible to the observer positioned on the +Z side of the display device 600 becomes darker as the voltage applied to the nematic liquid crystal layer 106 increases. Accordingly, the display device 600 functions as a display device that displays the display of the display panel 610 through the half mirror 620, and also functions as a mirror that reflects the external light. The polarization modulation element 10 can suppress scattering of the linearly polarized light L1 and, as such, the observer positioned on the +Z side of the display device 600 can see the display of the display panel 610 with less blur.

When the polarization modulation element 10 is in the ON state, the polarization modulation element 10 maintains the polarization direction of the linearly polarized light L1, and emits the linearly polarized light L1 as emission light L2 for which the polarization direction is the X direction. The direction of the transmission axis of the second polarizing plate 430 is the Y direction and, as such, as illustrated in FIG. 26, the emission light L2 cannot transmit through the second polarizing plate 430. Accordingly, the observer positioned on the +Z side of the display device 600 becomes unable to see the display of the display panel 610, and the display device 600 functions as a mirror that reflects the external light.

As described above, the polarization modulation element 10 can suppress scattering of the linearly polarized light L1 and, as such, the display device 600 can provide the observer with a display with less blur.

### Embodiment 7

In the present embodiment, a three-dimensional-image display device 700 using the polarization modulation element 10 of Embodiment 1 is described. In one example, the polarization modulation element 10 is used in a three-dimensional-image display device 700 that displays three-dimensional images by a depth fused 3D (DFD) method. The polarization modulation element 10 functions as a polarization switching element in the three-dimensional-image display device 700.

In one example, the three-dimensional-image display device 700 is combined with eyepieces, and is used as a head-mounted display. Note that, in the present embodiment, an example of a three-dimensional-image display device 700 that uses a monochrome liquid crystal panel is described.

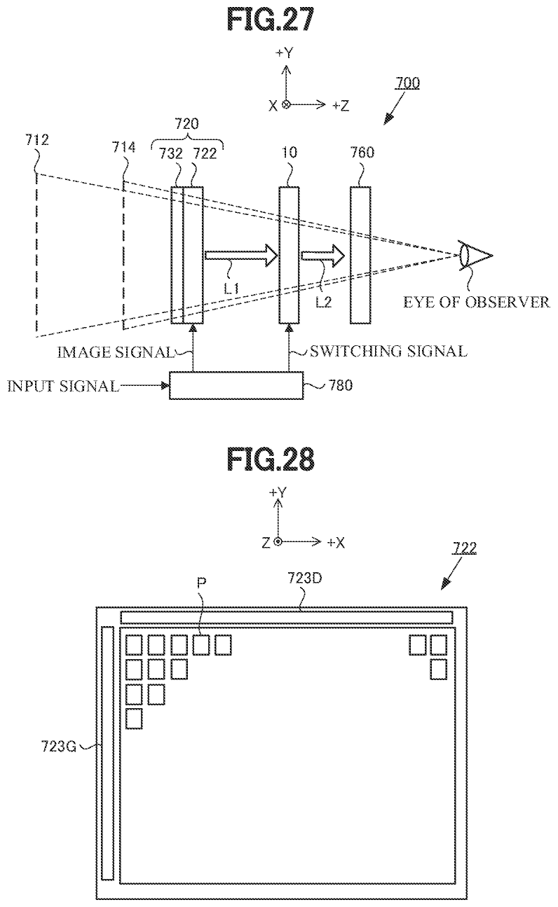

As illustrated in FIG. 27, the three-dimensional-image display device 700 includes a display unit 720, the polarization modulation element 10, a polarized bifocal lens 760, and a controller 780. The display unit 720 sequentially displays a first image and a second image in time divisions. The display unit 720 emits display light, expressing the first image and the second image, to the polarization modulation element 10 as linearly polarized light L1 incident on the polarization modulation element 10. The polarization modulation element 10 switches the polarization direction of the linearly polarized light L1 emitted from the display unit 720 to a predetermined first direction and a predetermined second direction. The polarized bifocal lens 760 forms each of the first image and the second image as a virtual image on each of a first display surface 712 and a second display surface 714. The controller 780 supplies, to the display unit 720, a first image signal expressing the first image and a second image signal expressing the second image. Additionally, the controller 780 controls the switching of the polarization direction of the polarization modulation element 10.

In the present embodiment, the predetermined first direction is the Y direction, and the predetermined second direction is the X direction. The first image signal expressing the first image and the second image signal expressing the second image may be collectively referred to as “image signals.”

The display unit 720 of the three-dimensional-image display device 700 includes a liquid crystal display panel 722 and a light source 732. The liquid crystal display panel 722 modulates, on the basis of the first image signal expressing the first image and the second image signal expressing the second image supplied from the controller 780, light emitted from the light source 732, thereby sequentially displaying the first image and the second image in time divisions. The liquid crystal display panel 722 emits the display light expressing the images (for example, the first image and the second image) as linearly polarized light L1 for which the polarization direction is the predetermined first direction (the Y direction). The linearly polarized light L1 emitted from the liquid crystal display panel 722 enters the polarization modulation element 10.

The first image and the second image are two-dimensional images obtained by projecting, from the side of the observer, a display subject on each of the first display surface 712 and the second display surface 714 that are positioned at different positions in a depth direction (the −Z direction) from the perspective of the observer. The first display surface 712 and the second display surface 714 are described later.

In one example, the liquid crystal display panel 722 is implemented as a transmissive TN liquid crystal panel that is active matrix driven by thin film transistors (TFT). As illustrated in FIG. 28, the liquid crystal display panel 722 includes pixels P arranged in a matrix, a gate driver 723G and a data driver 723D. The gate driver 723G sequentially selects the pixels P by row, and performs line progressive scanning in the −Y direction. The data driver 723D supplies, to each of the selected pixels P, voltage corresponding to the image signals, thereby writing the image signals to each of the pixels P. Note that FIG. 28 illustrates only a portion of the pixels P arranged in the matrix. Additionally, the liquid crystal display panel 722 includes a polarizing plate, a liquid crystal, and the like (not illustrated in the drawings).

The light source 732 is a light source that emits light on the liquid crystal display panel 722. As illustrated in FIG. 27, the light source 732 is arranged on a back surface side (the −Z side) of the liquid crystal display panel 722. In one example, the light source 732 is implemented as a direct back light. The light source 732 includes a white LED element, a reflective sheet, a diffusion sheet, and the like (all not illustrated in the drawings).

The polarization modulation element 10 of the three-dimensional-image display device 700 switches, on the basis of a switching signal that is supplied from the controller 780 and is synchronized with the image signals, the polarization direction of the linearly polarized light L1, that is emitted from the display unit 720 and that enters the light incident-side substrate 102, between the predetermined first direction (the Y direction) and the predetermined second direction (the X direction). Specifically, when the first image is displayed on the liquid crystal display panel 722 of the display unit 720 and the linearly polarized light L1 is the display light of the first image, the polarization modulation element 10 maintains the polarization direction of the incident linearly polarized light L1 in the Y direction and emits. Meanwhile, when the second image is displayed on the liquid crystal display panel 722 of the display unit 720 and the linearly polarized light L1 is the display light of the second image, the polarization modulation element 10 switches the polarization direction of the incident linearly polarized light L1 to the X direction and emits.

When an ON level switching signal is supplied to the polarization modulation element 10, the polarization modulation element 10 emits the emission light L2 (the ON state) while maintaining the polarization direction of the linearly polarized light L1 in the Y direction. Meanwhile, when an OFF level switching signal is supplied, the polarization modulation element 10 rotates the polarization direction of the linearly polarized light L1 90°, and emits emission light L2 for which the polarization direction is the X direction (the initial alignment state). The emission light L2 emitted from the polarization modulation element 10 enters the polarized bifocal lens 760. The switching signal is described later.

The polarized bifocal lens 760 of the three-dimensional-image display device 700 is a lens for which the focal distance for the emission light L2 emitted from the polarization modulation element 10 differs depending on the polarization direction (the X direction and the Y direction) of the emission light L2. The polarized bifocal lens 760 forms each of the first image and the second image as a virtual image from the perspective of the observer on each of the first display surface 712 and the second display surface 714. The first display surface 712 and the second display surface 714 are imaginary display surfaces positioned at different positions in the depth direction (the −Z direction) from the perspective of the observer. In the present embodiment, as illustrated in FIG. 27, from the perspective of the observer, the first display surface 712 and the second display surface 714 are positioned farther away than the display unit 720. Additionally, the second display surface 714 is positioned more to the observer side (the −Z side) than the first display surface 712.

The observer views the virtual image of the first image on the first display surface 712 and the virtual image of the second image on the second display surface 714 that are sequentially displayed in time divisions, and recognizes that the display subject is positioned between the first display surface 712 and the second display surface 714. The position of the display subject that the observer recognizes can be changed by adjusting a brightness (for example, the luminance) ratio of the first image to the second image. For example, when the brightness ratio of the first image to the second image is 1:1, the observer recognizes that the display subject is positioned between the first display surface 712 and the second display surface 714.

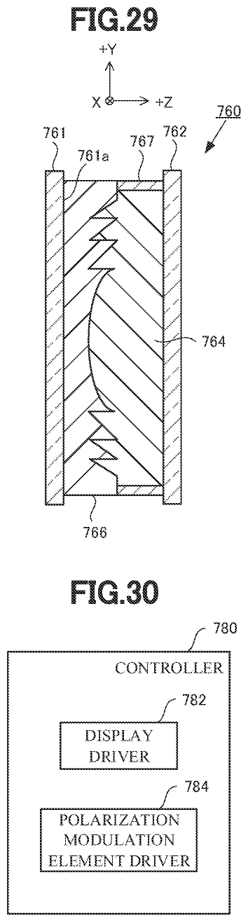

In one example, the polarized bifocal lens 760 is implemented as a liquid crystal lens. As illustrated in FIG. 29, the polarized bifocal lens (the liquid crystal lens) 760 includes a first light-transmitting substrate 761, a second light-transmitting substrate 762, and a liquid crystal 764.

In one example, the first light-transmitting substrate 761 and the second light-transmitting substrate 762 are implemented as glass substrates. The first light-transmitting substrate 761 includes a resin Fresnel lens 766 on a main surface 761a that opposes the second light-transmitting substrate 762. The first light-transmitting substrate 761 and the second light-transmitting substrate 762 are adhered to each other by a seal material 767, and sandwich the liquid crystal 764. In one example, the liquid crystal 764 is implemented as a nematic liquid crystal that has positive refractive index anisotropy Δn. The liquid crystal 764 is aligned in the Y direction by a non-illustrated alignment film.

When the emission light L2 for which the polarization direction is the Y direction (the display light of the first image) enters the polarized bifocal lens 760, the liquid crystal (the nematic liquid crystal) 764 that has positive refractive index anisotropy Δn is aligned with the Y direction and, as such, the focal distance of the polarized bifocal lens 760 for the emission light L2 is short, and the first image is formed on the first display surface 712. Meanwhile, when the emission light L2 for which the polarization direction is the X direction (the display light of the second image) enters the polarized bifocal lens 760, the focal distance of the polarized bifocal lens 760 for the emission light L2 is long, and the second image is formed on the second display surface 714.

The controller 780 of the three-dimensional-image display device 700 controls the liquid crystal display panel 722 of the display unit 720, and the polarization modulation element 10 on the basis of input signals input from a non-illustrated external device. As illustrated in FIG. 30, the controller 780 includes a display driver 782 and a polarization modulation element driver 784.

The display driver 782 of the controller 780 generates, from the input signals, the first image signal for displaying the first image and the second image signal for displaying the second image. Additionally, the display driver 782 supplies the image signals to the liquid crystal display panel 722. Furthermore, the display driver 782 supplies, to the polarization modulation element driver 784, a synchronization signal that synchronizes the start of supplying of the image signals.

The polarization modulation element driver 784 of the controller 780 generates a switching signal on the basis of the synchronization signal supplied from the display driver 782. The polarization modulation element driver 784 supplies the generated switching signal to the polarization modulation element 10. In the present embodiment, when the first image is to be displayed on the liquid crystal display panel 722, the polarization modulation element driver 784 sets the switching signal to the ON level (the predetermined voltage) and supplies the switching signal to the polarization modulation element 10.

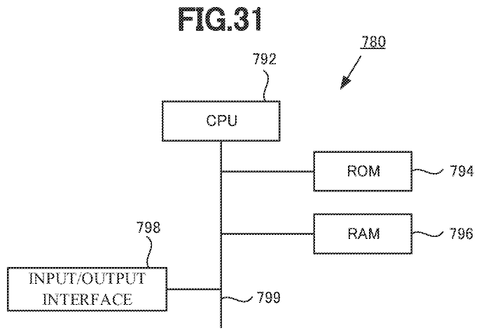

FIG. 31 illustrates the hardware configuration of the controller 780. The controller 780 includes a central processing unit (CPU) 792, a read-only memory (ROM) 794, a random access memory (RAM) 796, and an input/output interface 798. The CPU 792, the ROM 794, the RAM 796, and the input/output interface 798 are connected by a bus 799. The CPU 792 executes various types of processings. The ROM 794 stores programs and data. The RAM 796 stores data. The input/output interface 798 inputs and outputs signals to and from the CPU 792, the liquid crystal display panel 722, the polarization modulation element 10, and the external device. The CPU 792 executes the programs stored in the ROM 794 to realize the functions of the controller 780.

The polarization modulation element 10 can suppress scattering of the linearly polarized light L1 and, as such, the three-dimensional-image display device 700 can provide the observer with a display with less blur.

### MODIFIED EXAMPLES

Embodiments have been described, but various modifications can be made to the present disclosure without departing from the spirit and scope of the present disclosure.

In the polarization modulation element 10 of Embodiment 1, the twist angle α of the nematic liquid crystal layer 106 is 90°, but the twist angle α of the nematic liquid crystal layer 106 is not limited to 90°.

In the polarization modulation element 20 of Embodiment 2 and the polarization modulation element 30 of Embodiment 3, the twist angles α of the TN cells 200 forming the polarization modulation element 20, 30 are equal. However, a configuration is possible in which the twist angles α of the TN cells 200 forming the polarization modulation element 20, 30 are mutually different. Additionally, the sum of the twist angles α of each of the nematic liquid crystal layers 106 of the TN cells 200 is not limited to 90°.

The polarization modulation element 20 of Embodiment 2 includes four of the TN cells 200. It is sufficient that the polarization modulation element 20 includes a plurality (two or more) of the TN cells 200. For example, a configuration is possible in which the polarization modulation element 20 includes two TN cells 200 in which the twist angle α of each nematic liquid crystal layer 106 is 45°.

The polarization modulation element 30 of Embodiment 3 includes four of the TN cells 200. It is sufficient that the polarization modulation element 30 includes three or more of the TN cells 200. For example, a configuration is possible in which the polarization modulation element 30 includes three TN cells 200 in which the twist angle α of each nematic liquid crystal layer 106 is 30°.

In the polarization modulation element 30 of Embodiment 3, in the second TN cell 220 and the third TN cell 230 that are adjacent, the alignment axis direction 224 of the light emitting-side substrate 104 of the TN cell 220 and the alignment axis direction 232 of the light incident-side substrate 102 of the TN cell 230 are orthogonal to each other. However, it is sufficient that, in the polarization modulation element 30, in at least one of the TN cells 200 that are adjacent, the alignment axis direction 250 of the light emitting-side substrate 104 of one of the TN cells 200 and the alignment axis direction 250 of the light incident-side substrate 102 of another of the TN cells 200 are orthogonal to each other. For example, a configuration is possible in which, in a polarization modulation element 30 including four TN cells 200, in a first TN cell 200 and a second TN cell 200, and in a third TN cell 200 and a fourth TN cell 200, the alignment axis direction 250 of the light emitting-side substrate 104 of one of the TN cells 200 and the alignment axis direction 250 of the light incident-side substrate 102 of the other of the TN cells 200 are orthogonal to each other.

A configuration is possible in which the smart glass 400, the one-way mirror 500, the display device 600, and the three-dimensional-image display device 700 include the polarization modulation element 20 or the polarization modulation element 30 instead of the polarization modulation element 10.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A polarization modulation element comprising:
a light incident-side substrate on which linearly polarized light is incident;
a light emitting-side substrate opposing the light incident-side substrate;
a nematic liquid crystal layer that is twist-aligned and is sandwiched between the light incident-side substrate and the light emitting-side substrate; and
a polymer that is dispersed in the nematic liquid crystal layer and that is aligned according to a twist-alignment of the nematic liquid crystal layer, wherein
an alignment axis direction of the light incident-side substrate and a polarization direction of the linearly polarized light are orthogonal to each other.

2. The polarization modulation element according to claim 1, wherein
a twist angle of the nematic liquid crystal layer is 90°.

3. The polarization modulation element according to claim 1, wherein
a content of the polymer is from 1 wt % to 10 wt % with respect to a nematic liquid crystal composition that forms the nematic liquid crystal layer.

4. A polarization modulation element comprising:
a plurality of twisted nematic liquid crystal cells, each including a light incident-side substrate, a light emitting-side substrate opposing the light incident-side substrate, a nematic liquid crystal layer that is twist-aligned and is sandwiched between the light incident-side substrate and the light emitting-side substrate, and a polymer that is dispersed in the nematic liquid crystal layer and that is aligned according to a twist-alignment of the nematic liquid crystal layer, wherein
a twist direction of the nematic liquid crystal layer of each of the plurality of twisted nematic liquid crystal cells is identical,
the plurality of nematic liquid crystal cells are sequentially stacked with the light incident-side substrate of one of the twisted nematic liquid crystal cells opposing the light emitting-side substrate of another of the twisted nematic liquid crystal cells,
in the twisted nematic liquid crystal cells that are adjacent, of the plurality of twisted nematic liquid crystal cells, an alignment axis direction of the light emitting-side substrate of one of the nematic liquid crystal cells and an alignment axis direction of the light incident-side substrate of another of the nematic liquid crystal cells match, and
an alignment axis direction of the light incident-side substrate of a first twisted nematic liquid crystal cell, of the plurality of twisted nematic liquid crystal cells, on which linearly polarized light is incident and a polarization direction of the linearly polarized light are orthogonal to each other.

5. The polarization modulation element according to claim 4, wherein
a sum of a twist angle of the nematic liquid crystal layer of each of the nematic liquid crystal layer cells is 90°.

6. The polarization modulation element according to claim 4, wherein
a content of the polymer is from 1 wt % to 10 wt % with respect to a nematic liquid crystal composition that forms the nematic liquid crystal layer.

7. A polarization modulation element comprising:
three or more twisted nematic liquid crystal cells, each including a light incident-side substrate, a light emitting-side substrate opposing the light incident-side substrate, a nematic liquid crystal layer that is twist-aligned and is sandwiched between the light incident-side substrate and the light emitting-side substrate, and a polymer that is dispersed in the nematic liquid crystal layer and that is aligned according to a twist-alignment of the nematic liquid crystal layer, wherein
a twist direction of the nematic liquid crystal layer of each of the twisted nematic liquid crystal cells is identical,
the twisted nematic liquid crystal cells are sequentially stacked with the light incident-side substrate of one of the twisted nematic liquid crystal cells opposing the light emitting-side substrate of another of the twisted nematic liquid crystal cells,
in at least one group of the twisted nematic liquid crystal cells that are adjacent, an alignment axis direction of the light emitting-side substrate of one of the twisted nematic liquid crystal cells and an alignment axis direction of the light incident-side substrate of another of the twisted nematic liquid crystal cells are orthogonal to each other,
in the twisted nematic liquid crystal cells that are adjacent, except for the at least one group of the twisted nematic liquid crystal cells that are adjacent, the alignment axis direction of the light emitting-side substrate of one of the twisted nematic liquid crystal cells and the alignment axis direction of the light incident-side substrate of another of the twisted nematic liquid crystal cells match, and
an alignment axis direction of the light incident-side substrate of a first twisted nematic liquid crystal cell, of the twisted nematic liquid crystal cells, on which linearly polarized light is incident and a polarization direction of the linearly polarized light are orthogonal to each other.

8. The polarization modulation element according to claim 7, wherein
a sum of a twist angle of the nematic liquid crystal layer of each of the nematic liquid crystal layer cells is 90°.

9. The polarization modulation element according to claim 7, wherein
a content of the polymer is from 1 wt % to 10 wt % with respect to a nematic liquid crystal composition that forms the nematic liquid crystal layer.

10. A smart glass comprising:
the polarization modulation element according to claim 1;
a light-transmitting substrate that is disposed on a side of the polarization modulation element on which the linearly polarized light is incident, and on which external light is incident;
a first polarizing plate that is disposed between the light-transmitting substrate and the polarization modulation element, and that emits, to the polarization modulation element, the external light that transmits through the light-transmitting substrate as the linearly polarized light incident on the polarization modulation element; and
a second polarizing plate on which emission light emitted from the polarization modulation element is incident, and that has a transmission axis that is orthogonal to a transmission axis of the first polarizing plate.

11. A one-way mirror comprising:
the polarization modulation element according to claim 1;
a half mirror that is disposed on a side of the polarization modulation element on which the linearly polarized light is incident, and on which external light is incident;
a first polarizing plate that is disposed between the half mirror and the polarization modulation element, and that emits, to the polarization modulation element, the external light that transmits through the half mirror as the linearly polarized light incident on the polarization modulation element; and
a second polarizing plate on which emission light emitted from the polarization modulation element is incident, and that has a transmission axis that is orthogonal to a transmission axis of the first polarizing plate.

12. A display device comprising:
the polarization modulation element according to claim 1;
a display panel that is disposed on a side of the polarization modulation element on which the linearly polarized light is incident, and that emits display light toward the polarization modulation element;
a first polarizing plate that is disposed between the polarization modulation element and the display panel, and that emits, to the polarization modulation element, the display light of the display panel as the linearly polarized light incident on the polarization modulation element;
a second polarizing plate on which emission light emitted from the polarization modulation element is incident, and that has a transmission axis that is orthogonal to a transmission axis of the first polarizing plate; and
a half mirror on which the emission light of the polarization modulation element that transmits through the second polarizing plate is incident.

13. A three-dimensional-image display device comprising:
the polarization modulation element according to claim 1;
a display unit that sequentially displays a first image and a second image, and emits display light of the first image and display light of the second image as the linearly polarized light, that enters the polarization modulation element, for which a polarization direction is a predetermined first direction; and
a polarized bifocal lens into which emission light emitted from the polarization modulation element enters, and in which a focal distance for the emission light emitted from the polarization modulation element differs based on the polarization direction of the emission light, wherein
the first image and the second image are two-dimensional images obtained by projecting, from a side of an observer, a display subject on each of a first display surface and a second display surface positioned at different positions in a depth direction from a perspective of the observer,
the polarization modulation element maintains the polarization direction of the linearly polarized light in the predetermined first direction and emits when the linearly polarized light is the display light of the first image, and changes the polarization direction of the linearly polarized light to a second direction orthogonal to the predetermined first direction and emits when the linearly polarized light is the display light of the second image, thereby switching the polarization direction of the emission light between the predetermined first direction and the second direction and emitting, and
the polarized bifocal lens forms each of the first image and the second image as a virtual image on each of the first display surface and the second display surface.
